(19) United States
(12) Patent Application Publication
(10) Pub. No.: US 2016/0248559 A1
(43) Pub. Date: Aug. 25, 2016

(54) Inter-Node Interference Reduction Method, Node and System

(71) Applicant: ZTE CORPORATION, Shenzhen, Guangdong (CN)

(72) Inventors: Senba GUO, Shenzhen City, Guangdong Province (CN); Jun XU, Shenzhen City, Guangdong Province (CN); Yu Ngok LI, Shenzhen City, Guangdong Province (CN); Yunfeng SUN, Shenzhen City, Guangdong Province (CN)

(73) Assignee: ZTE CORPORATION, Shenzhen City, Guangdong Province (CN)

(21) Appl. No.: 15/028,283

(22) PCT Filed: May 22, 2014
(86) PCT No.: PCT/CN2014/078174

§ 371 Date: Apr. 8, 2016

(30) Foreign Application Priority Data
Oct. 8, 2013 (CN) 201310467745.4

(51) Int. Cl. H04L 5/00; H04J 11/00

(52) U.S. Cl. CPC H04L 5/0035; H04L 5/0073; H04J 11/0053; H04W 88/08

(57) ABSTRACT

An inter-node interference reduction method, node and system, wherein the method includes: a first node obtaining link state information fed back by a terminal within the coverage range of the first node; the first node calculating joint information reflecting the interference of a second node with the terminal based on the link state information, and sending the joint information to the second node; the second node scheduling a terminal within its own coverage range based on the joint information, wherein the joint information includes a codebook limit cluster and further includes one or more of a power level limit cluster, a priority indication information cluster and an interference level indication information cluster, and a correspondence exists between constituent elements of any piece(s) of information within the joint information and constituent elements of other information except the any piece(s) of information within the joint information

### CROSS-REFERENCE TO RELATED APPLICATION(S)

This application is the U.S. National Phase application of PCT application number PCT/CN2014/078174 having a PCT filing date of May 22, 2014, which claims priority of Chinese patent application 201310467745.4 filed on Oct. 8, 2013, the disclosures of which are hereby incorporated by reference.

### TECHNICAL FIELD

The present invention relates to inter-node interference reduction technologies, and more particularly, to an inter-node interference reduction method, node and system.

### BACKGROUND OF RELATED ART

The R8 and R9 versions of the LTE design Common Reference Signal (CRS) to measure the quality of a channel and to demodulate received data symbols. The user equipment (UE) can execute a channel quality measurement via a CRS to decide which target cell to execute a cell reselection and the switch. When the UE executes the channel quality measurement in a connected state, if the interference level is high, its physical layer may also disconnect the connection through a wireless link connection failure signaling related to a high layer.

In the LTE R8 stage, in order to avoid inter-cell interference, the Inter-Cell-Interferece-Cancelling (ICIC) method was introduced, and with this method, the base station can achieve an interference cancellation by calculating whether the Relative Narrowband TX Power (RNTP) exceeds a predefined threshold, if it exceeds the predefined threshold, an inter-node interaction signaling is used to notify neighboring nodes that the corresponding physical resource blocks may cause relatively large interference with the neighboring nodes, if it does not exceed the predefined threshold, the inter-node interaction signaling is used to inform the neighboring nodes that the corresponding physical resource blocks do not cause relatively large interference with the neighboring nodes. Since the interference cancellation method only compares power values, the factor in the consideration is single.

In the LTE R10 and R11 stages, the concept of Almost Blanking Subframe (ABS) was introduced, and the main purpose of introducing the ABS is to reduce interference of a high power node with a low power node, the high power node does not transmit data in ABS subframes or transmit data with a low power to reduce interference with the low-power node.

The coordinated multi-point transmission technology was introduced in the LTE R11 stage, and in order to better implement this technology, the standard introduced the concept of channel state information process (CSI Process). The CSI Process supports different cells transmitting data to a terminal in different subframes, so as to ensure selecting the serving cell with the optimal performance at different times, but the CSI Process requires that cells participating in the interference avoidance have an ideal backhaul, which limits application scenarios.

In the LTE R12 stage, due to the introduction of the concept of Small Cell, it may need to support a denser cell distribution in the future, and the coverage range of a macro sector may cover more small cells, as shown in FIG. 1, this layout makes the problem of mutual interference of unit areas more serious in the future, and the non-ideal backhaul used between a plurality of cells also limits the message interaction between the cells via the backhaul. To ensure the signal quality of the user in small cells in the denser layout, it urgently needs a new inter-cell interference reduction mechanism.

### SUMMARY OF THE INVENTION

The embodiment of the present invention provides an inter-node interference reduction method, node and system to solve the technical problem of inter-node interference reduction in the case that the inter-cell backhaul is not ideal.

To solve the abovementioned technical problem, the following technical solution will be used:

an inter-node interference reduction method, wherein the method comprises:

a first node obtaining link state information fed back by a terminal within a coverage range of the first node;

the first node calculating joint information reflecting interference of a second node with the terminal based on the link state information, and sending the joint information to the second node; and

the second node scheduling a terminal within a coverage range of the second node based on the joint information;

wherein, the joint information comprises a codebook limit cluster, and further comprises one or more of a power level limit cluster, a priority indication information cluster and an interference level indication information cluster, and a correspondence exists between constituent elements of any piece(s) of information in the joint information and constituent elements of other information except the any piece(s) of information in the joint information.

Alternatively, when the joint information comprises the priority indication information cluster, the priority indication information in the priority indication information cluster is represented in the following manner:

representing the priority indication information of a corresponding codeword by setting a priority indication signaling for a codeword in each codebook limit cluster;

or,

representing the priority indication information of a corresponding codeword based on an arrangement order or index value of the codeword in the codebook limit cluster, with a change of the arrange order of the codeword from front to back or the index value of the codeword from low to high, a priority of the codeword increasing, or, with a change of the arrangement order of the codeword from front to back or the index value of the codeword from low to high, a priority of the codeword decreasing.

Alternatively, the step of the first node calculating joint information reflecting interference of a second node with the terminal based on the link state information comprises:

the first node, based on the link state information in each basic unit resource, calculating the joint information reflecting the interference of the second node with the terminal in the basic unit resource;

wherein, the basic unit resource comprises one or more of the following information:

resource block, resource block pair, subband, resource block group (RBG), precoding resource group (PRG), subframe cluster, and radio frame cluster.

Alternatively,

when the basic unit resource comprises the resource blocks, the resource blocks are represented with a bitmap, each bit in the bitmap sequence represents one resource block, and a length of the bitmap sequence is equal to a number of all the resource blocks;

when the basic unit resource comprises the resource block pairs, the resource block pairs are represented with a bitmap, each bit in the bitmap sequence represents one resource block pair, and a length of the bitmap sequence is equal to a number of all the resource block pairs;

when the basic unit resource comprises the subbands, the subbands are represented with a bitmap, each bit in the bitmap sequence represents one subband, and a length of the bitmap sequence is equal to a number of all the subbands;

when the basic unit resource comprises the RBGs, the RBGs are represented with a bitmap, each bit in the bitmap sequence represents one RBG, and a length of the bitmap sequence is equal to a number of all the RBGs;

when the basic unit resource comprises the PRGs, the PRGs are represented with a bitmap, each bit in the bitmap sequence represents one PRG, and a length of the bitmap sequence is equal to a number of all the PRGs;

when the basic unit resource comprises the subframe cluster, the subframe cluster is represented with a bitmap, each bit in the bitmap sequence represents one subframe, and a length of the bitmap sequence is equal to a number of all the subframes;

when the basic unit resource comprises the subframe cluster, the sub-frame cluster is represented with a bitmap, each bit in the bitmap sequence represents one subframe, and a length of the bitmap sequence is equal to a number of all the subframes; and

when the basic unit resource comprises the radio frame cluster, the radio frame cluster is represented with a bitmap, each bit in the bitmap sequence represents one radio frame, and a length of the bitmap sequence is equal to a number of all the radio frames;

Alternatively, the step of the second node scheduling a terminal within a coverage range of the second node based on the joint information comprises:

the second node judging whether terminal codewords within the coverage range of the present node are all included in the codebook limit cluster in the joint information, if there exist a terminal codeword not included in the codebook limit cluster, then scheduling a terminal corresponding to the terminal codeword; if the terminal codewords within the coverage range of the present node are all included in the codebook limit cluster in the joint information, selecting a terminal to be scheduled based on other information except the codebook limit cluster in the joint information, or not scheduling a terminal.

Alternatively, when the joint information comprises the power level limit cluster, the step of selecting a terminal to be scheduled based on other information except the codebook limit cluster in the joint information comprises:

calculating a system gain generated by scheduling a terminal of a corresponding codeword based on the power level limit cluster, and selecting a terminal with a maximum system gain as the terminal to be scheduled.

The embodiment of the present invention further provides an inter-node interference reduction node, and the node comprises an information transceiving unit and an interference information calculating unit, wherein

the information transceiving unit is configured to: obtain link state information fed back by a terminal within a coverage range of the node, send the link state information to the interference information calculating unit; and send joint information sent by the interference information calculating unit to a second node that interferes with the terminal; and

the interference information calculating unit is configured to: calculate joint information reflecting interference of the second node with the terminal based on the link state information, and return the joint information to the information transceiving unit;

wherein, the joint information comprises a codebook limit cluster, and further comprises one or more of a power level limit cluster, a priority indication information cluster and an interference level indication cluster, and a correspondence exists between constituent elements of any piece(s) of information in the joint information and constituent elements of other information except the any piece(s) of information in the joint information.

Alternatively, when the joint information comprises the priority indication information cluster, the priority indication information in the priority indication information cluster is represented in the following manner:

representing the priority indication information of a corresponding codeword by setting a priority indication signaling for a codeword in each codebook limit cluster;

or,

representing the priority indication information of a corresponding codeword based on an arrangement order or index value of the codeword in the codebook limit cluster, with a change of the arrangement order from front to back or the index value from low to high of the codeword, a priority of the codeword increasing, or, with a change of the arrangement order of the codeword from front to back or the index value of the codeword from low to high, a priority of the codeword decreasing.

Alternatively, the interference information calculating unit is configured to calculate joint information reflecting interference of the second node with the terminal based on the link state information in the following manner:

based on the link state information in each basic unit resource, calculating the joint information reflecting the interference of the second node with the terminal in the basic unit resource;

wherein, the basic unit resource comprises one or more of the following information:

resource block, resource block pair, subband, resource block group (RBG), precoding resource group (PRG), subframe cluster, and radio frame cluster.

Alternatively,

when the basic unit resource comprises the resource blocks, the resource blocks are represented with a bitmap, each bit in the bitmap sequence represents one resource block, and a length of the bitmap sequence is equal to a number of all the resource blocks;

when the basic unit resource comprises the resource block pairs, the resource block pairs are represented with a bitmap, each bit in the bitmap sequence represents one resource block pair, and a length of the bitmap sequence is equal to a number of all the resource block pairs;

when the basic unit resource comprises the subbands, the subbands are represented with a bitmap, each bit in the bitmap sequence represents one subband, and a length of the bitmap sequence is equal to a number of all the subbands;

when the basic unit resource comprises the RBGs, the RBGs are represented with a bitmap, each bit in the bitmap sequence represents one RBG, and a length of the bitmap sequence is equal to a number of all the RBGs;

when the basic unit resource comprises the PRGs, the PRGs are represented with a bitmap, each bit in the bitmap sequence represents one PRG, and a length of the bitmap sequence is equal to a number of all the PRGs;

when the basic unit resource comprises the subframe cluster, the subframe cluster is represented with a bitmap, each bit in the bitmap sequence represents one subframe, and a length of the bitmap sequence is equal to a number of all the subframes; and

when the basic unit resource comprises the radio frame cluster, the radio frame cluster is represented with a bitmap, each bit in the bitmap sequence represents one radio frame, and a length of the bitmap sequence is equal to a number of all the radio frames.

The embodiment of the present invention further provides an inter-node interference reduction node, the node comprises an information obtaining unit and a scheduling unit, wherein,

the information obtaining unit is configured to: obtain joint information coming from a first node and reflecting interference of the present node with a terminal within a coverage range of the first node, and sending the joint information to the scheduling unit;

the scheduling unit is configured to: schedule a terminal within a coverage range of the present node based on the joint information;

wherein, the joint information comprises a codebook limit cluster, and further comprises one or more of a power level limit cluster, a priority indication information cluster and an interference level indication information cluster.

Alternatively, the scheduling unit is configured to schedule a terminal within a coverage range of the present node based on the joint information in the following manner:

judging whether terminal codewords within the coverage range of the present node are all included in the codebook limit cluster in the joint information, if there exist a terminal codeword not included in the codebook limit cluster, then scheduling a terminal corresponding to the terminal codeword; if the terminal codewords within the coverage range of the present node are all included in the codebook limit cluster in the joint information, selecting a terminal to be scheduled based on information except the codebook limit cluster in the joint information, or not scheduling a terminal.

Alternatively, when the joint information comprises the power level limit cluster, the scheduling unit is configured to select a terminal to be scheduled based on information except the codebook limit cluster in the joint information in the following manner:

Calculating a system gain generated by scheduling a terminal of a corresponding codeword based on the power level limit cluster, and selecting a terminal with a maximum system gain as the terminal to be scheduled.

The embodiment of the present invention further provides an inter-node interference reduction system, comprising: the abovementioned node comprising the information transceiving unit and the interference information calculating unit; as well as the abovementioned node comprising the information obtaining unit and the scheduling unit.

The abovementioned technical solution obtains joint information of the interference of a neighboring node with a terminal of the present node from the link state information coming from the terminal, through the interference information interaction between the present node and the neighboring node, the neighboring node learns reasons of the interference, and then further schedules a terminal which would generate relatively small interference with the node, this technical solution does not require to use an ideal backhaul between the cells because the wireless link is used between the cells to interact, and the joint information of the interference, learned by the present node, of the neighboring nodes with a terminal of the present node comprises a plurality of factors that cause the interference, so that the interference suppression is more reasonable.

### BRIEF DESCRIPTION OF THE DRAWINGS

FIG. 1 is a schematic diagram of a scenario of a low power node RRH in a Macro coverage in the related art;

FIG. 2 is a flow chart of an inter-node interference reduction method in accordance with an embodiment of the present invention;

FIG. 3 is a schematic diagram of a format of joint information sent by TPX to TPY in accordance with an application example of the present invention;

FIG. 4 is a schematic diagram of a format of joint information sent by the TPY to the TPX in accordance with an application example of the present invention;

FIG. 5 is a schematic diagram of the composition structure of an inter-node interference reduction node in accordance with an embodiment of the present invention;

FIG. 6 is a schematic diagram of the composition structure of the inter-node interference reduction node in accordance with an embodiment of the present invention.

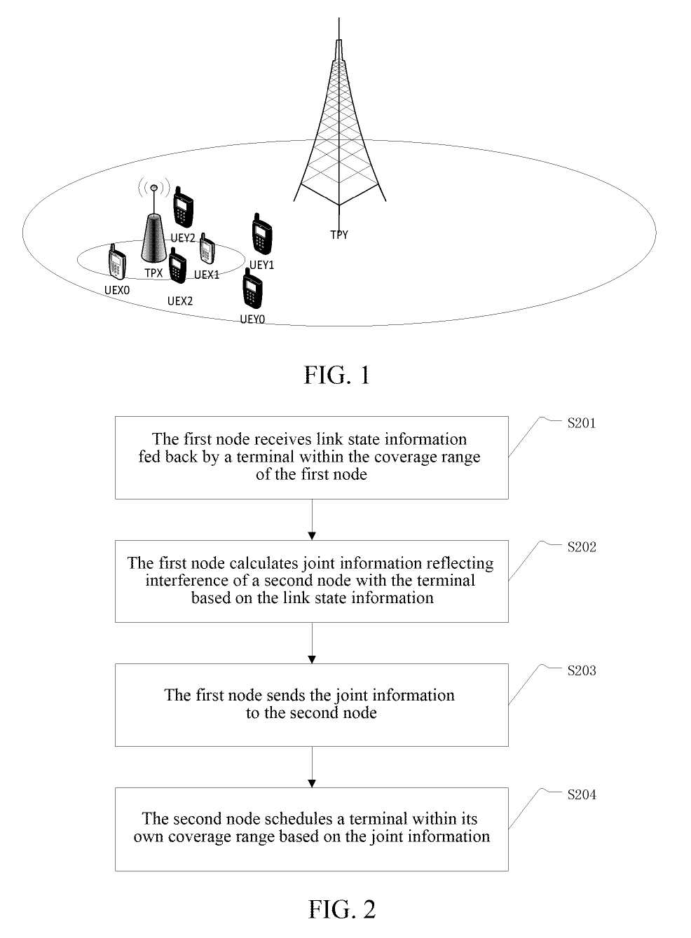

### PREFERRED EMBODIMENTS OF THE INVENTION

Hereinafter, in conjunction with the accompanying drawings, the embodiments of the present invention will be described in detail. It should be noted that, in the case of no conflict, embodiments and features in the embodiments of the present application may be arbitrarily combined with each other.

FIG. 2 is a flow chart of the inter-node interference reduction method in accordance with the present embodiment.

In step 201, the first node obtains link state information fed back by a terminal within the coverage range of the first node;

In step 202, the first node calculates joint information reflecting interference of a second node with the terminal based on the link state information;

the joint information comprises a codebook restriction cluster, and further comprises one or more of a power level limit cluster, a priority indication information cluster and an interference level indication information cluster, for example, the joint information may be: the codebook limit cluster and the power level limit cluster, the codebook limit cluster and the priority indication information cluster, the codebook limit cluster and the interference level indication information cluster, or the codebook limit cluster and the power level limit cluster as well as the priority indication information cluster; correspondences exist between constituent elements of any piece(s) of information in the joint information and constituent elements of other information except the any piece(s) of information in the joint information, if the joint information is the codebook limit cluster and the power level limit cluster, each codeword in the codebook limit cluster has a corresponding power level limit value in the power level limit cluster;

the codebook limit cluster refers to a set consisting of codewords generating interference with the terminal; the codewords in the codebook limit cluster may use codewords with rank being 1 to reduce the signaling overhead;

the power level limit cluster and the interference level indication information cluster respectively limit the maximum allowed power and the minimum generated interference for the second node scheduling terminals corresponding to the codewords; the power limit level may reflect the interference level, and compared with a codeword with a low power limit level, a codeword with a high power limit level generates less interference with the first node;

the priority indication information cluster reflects priorities used by the codewords in the codebook limit cluster;

when the joint information comprises the priority indication information cluster, the priority indication information in the priority indication information cluster is represented in the following manner: representing the priority indication information of the corresponding codeword by setting a priority indication signaling for each codeword in the codebook limit cluster, wherein the abovementioned priority indication signaling can be represented through a bitmap sequence, for example, the bit 0 in the sequence is used to represent a low priority, 1 represents a high priority; or, representing the priority indication information of the corresponding codeword according to the arrangement order or index value of the codeword in the codeword limit cluster, wherein, with the change of the arrangement order of the codeword from front to back or the index value of the codeword from low to high, the priority of the codeword increases, or with the change of the arrangement order of the codeword from front to back or the index value of the codeword from low to high, the priority of the codeword decreases;

in S203, the first node sends the joint information to the second node;

the first node sends the joint information to the second node through a traditional carrier air interface (similar to a relay air interface) or a microwave air interface;

the first node calculating the joint information reflecting the interference of the second node with the terminal in the basic unit resource based on the link state information in each basic unit resource;

the basic unit resource comprises one or more of the following: resource block, resource block pair, subband, resource block group (RBG), precoding resource group (PRG), subframe cluster and radio frame cluster; wherein, the resource block, the resource block pair, the subband, the RBG and the PRG are also known as basic constituent elements of the basic unit resource;

when the basic unit resource comprises the resource blocks, the resource blocks are represented with a bitmap, and each bit in the bitmap sequence represents one resource block, and the length of the bitmap sequence is equal to the number of all the resource blocks;

when the basic unit resource comprises the resource block pairs, the resource block pairs are represented with a bitmap, each bit in the bitmap sequence represents one resource block pair, and the length of the bitmap sequence is equal to the number of all the resource block pairs;

when the basic unit resource comprises the subbands, the subbands are represented as a bitmap, each bit in the bitmap sequence represents one subband, and the length of the bitmap sequence is equal to the number of all the subbands;

when the basic unit resource comprises the RBGs, the RBGs are represented with a bitmap, each bit in the bitmap sequence represents one RBG, and the length of the bitmap sequence is equal to the number of all the RBGs;

when the basic unit resource comprises the PRGs, the PRGs are represented with a bitmap, each bit in the bitmap sequence represents one PRG, and the length of the bitmap sequence is equal to the number of all the PRGs;

when the basic unit resource comprises the subframe cluster, the subframe cluster is represented with a bitmap, each bit in the bitmap sequence represents one subframe, and the length of the bitmap sequence is equal to the number of all the subframes;

when the basic constituent elements of the basic unit resource comprise subframes, the subframe cluster may consist of a plurality of subframes configured with the same joint information, the joint information carried by different subframe clusters is different; the subframe cluster where the subframes are located is obtained through equation x=mod(SF, F(n)), wherein n is the subframe cluster index, SF is the subframe index, F(n) is the modulo coefficient corresponding to the subframe cluster n, and when x=n, it indicates that the subframe is located within the subframe cluster n;

when the basic unit resource comprises the radio frame cluster, the radio frame cluster is represented with a bitmap, each bit in the bitmap sequence represents one radio frame, and the length of the bitmap sequence is equal to the number of all the radio frames;

when the basic constituent elements of the basic unit resources comprise radio frames, the radio frame cluster may consist of a plurality of radio frames configured with the same joint information, the joint information carried by different radio frame clusters is different; the radio frame cluster where the radio frames are located is obtained by the equation x=mod (SF, F(n)), wherein n is the radio frame cluster index, SF is the subframe index, F(n) is the modulo coefficient corresponding to the radio frame cluster n, when x=n, it indicates that the radio frame is located within the radio frame cluster n;

in S204, the second node schedules a terminal within its own coverage range based on the joint information.

The second node judges whether terminal codewords within the coverage range of the present node are all included in the codebook limit cluster in the joint information, if there exist a terminal codeword not included in the codebook limit cluster, then schedules the terminal corresponding to the terminal codewords; if the terminal codewords within the coverage range of the present node are all included in the codebook limit cluster in the joint information, selects a terminal to be scheduled according to other information except the codebook limit cluster in the joint information, or it does not schedule a terminal.

Wherein, when selecting the terminal to be scheduled according to other information except the codebook limit cluster in the joint information, it is to select to use other information to schedule a terminal that has small interference with the terminal of the first node, for example, selecting a terminal with a high power level limit value, select a terminal with a high priority or a terminal with a low interference level, in addition, it may also calculate a system gain generated by scheduling the terminal of the corresponding codeword based on the power level limit cluster, and select a terminal with the maximum system gain as a terminal to be scheduled.

The first node and the second node may all devices with data transmission capability, such as Macro eNodeB, Pico, radio RF head (RRH), femto, HeNB, and Relay.

In the following, specific application examples will be used to describe the abovementioned embodiments in detail.

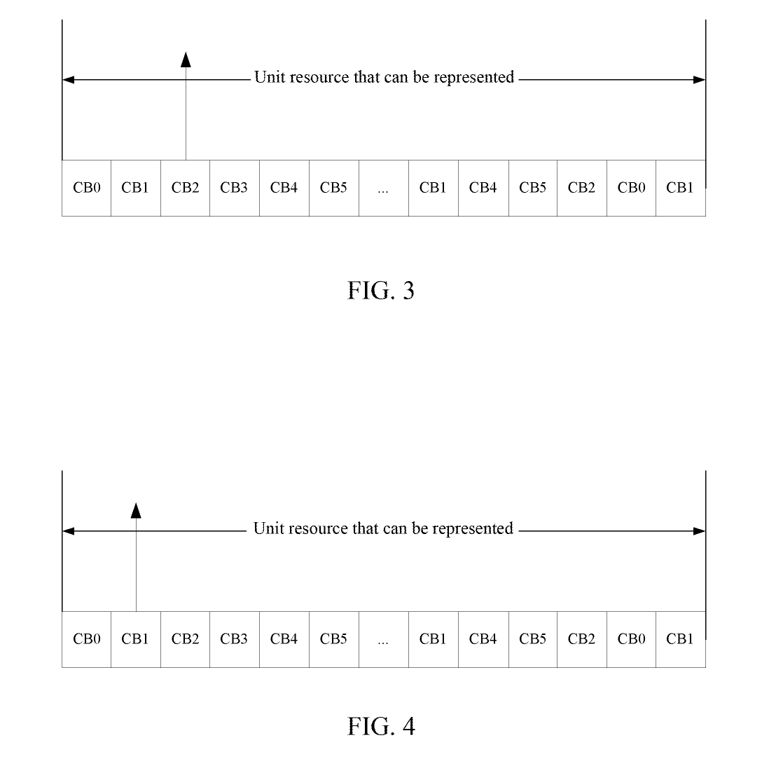

FIG. 3 is a schematic diagram of the joint information sent by the TPX to the TPY in the following application example. Each CBX represents one basic unit resource. Assume that, in the basic unit resource CB1, there is no codebook limit; in the basic unit resource CB1, it might carry the codebook limit cluster {B0, B1, B2, B3}, the corresponding power level limit cluster {P0, P1, P2, P3}, and the corresponding priority indication information cluster {PR0, PR1, PR2, PR3}; in the basic unit resource CB1, it may carry the codebook limit cluster {B0, B1, B2, B3}, the corresponding power level limit cluster {P0, P1, P2, P3}, and the corresponding priority indication information cluster {PR0, PR1, PR2, PR3}; in the basic unit resource CB2, it may carry the codebook limit cluster {B4, B5, B6, B7}, the corresponding power level limit cluster {P4, P5, P6, P7}, and the corresponding priority indication information cluster {PR4, PR5, PR6, PR7}; in the basic unit resource CB3, it may carry the codebook limit cluster {B8, B9, B10, B11}, the corresponding power level limit cluster {P8, P9, P10, P11}, and the corresponding priority indication information cluster {PR8, PR9, PR10, PR11}; in the basic unit resource CB4, it may carry the codebook limit cluster {B12, B13, B14, B15}, the corresponding power level limit cluster {P12, P13, P14, P15}, and the corresponding priority indication information cluster {PR12, PR13, PR14, PR15}; in the basic unit resource CB5, it may carry the codebook limit cluster {B0, B2, B6, B9}, the corresponding power level limit cluster {P0, P2, P6, P9}, and the priority indication information cluster {PR0, PR2, PR6, PR9};

FIG. 4 is a schematic diagram of the joint information sent by the TPY to the TPX in the following application example. Similarly, assume that, in the basic unit resource CB1, there is no codebook limit; in the basic unit resource CB1, it may carry the codebook limit cluster {B0, B1, B2, B3}, the corresponding power level limit cluster {P0, P1, P2, P3}, and the corresponding priority indication information cluster {PR0, PR1, PR2, PR3}; in the basic unit resource CB1, it may carry the codebook limit cluster {B0, B1, B2, B3}, the corresponding power level limit cluster {P0, P1, P2, P3}, and the corresponding priority indication information cluster {PR0, PR1, PR2, PR3}; in the basic unit resource CB2, it may carry the codebook limit cluster {B4, B5, B6, B7}, the corresponding power level limit cluster {P4, P5, P6, P7}, and the corresponding priority indication information cluster {PR4, PR5, PR6, PR7}; in the basic unit resource CB3, it may carry the codebook limit cluster {B8, B9, B10, B11}, the corresponding power level limit cluster {P8, P9, P10, P11}, and the corresponding priority indication information cluster {PR8, PR9, PR10, PR11}; in the basic unit resource CB4, it may carry the code limit cluster {B12, B13, B14, B15}, the corresponding power level limit cluster {P12, P13, P14, P15}, and the corresponding priority indication information cluster {PR12, PR13, PR14, PR15}; in the basic unit resource CB5, it may carry the codebook limit cluster {B0, B2, B6, B9}, the corresponding power level limit cluster {P0, P2, P6, P9}, and the corresponding priority indication information cluster {PR0, PR2, PR6, PR9};

It should be noted that the joint resource carried in the abovementioned base unit resource is not limited to the above examples. It may only comprise one or more of the codebook limit cluster, the power level limit cluster and the priority indication information cluster illustrated in the above figures.

### Application Example 1

this application scenario comprises two nodes TPX and TPY, there are three UEs, respectively UEX0, UEX1 and UEX2, under the TPX coverage, and there are three UEs, respectively UEY1, UEY1 and UEY2, under the TPY coverage.

In STEP1, the TPX measures or receives the link state information from the TPX to the UEXn and fed back by the UEXn (n=0, 1, 2);

in STEP2, the TPX calculates the interference codeword and the power level limit value corresponding to the codeword coming from the TPY based on the principle of minimizing interference; a plurality of interference codewords constitute a codebook limit cluster, a plurality of power level limit values constitute a power level limit cluster, and the codebook limit cluster and the power level limit cluster constitute the joint information;

in STEP3, the TPX sends the joint information to the TPY through the interface of the TPX and the TPY;

in STEP4, assuming that in the basic unit resource CB2, the optimal codewords of the UEY1, the UEY1 and the UEY2 are respectively B4, B5 and B6; when the TPY schedules, the TPY learns through the joint information that in the basic unit resource CB2, the optimal codewords corresponding to the UEY1, the UEY1 and the UEY2 are all within the codebook limit cluster, then the TPY does not schedule any UE in the CB2.

Similarly, the TPY measures or receives the link state information from the TPX to the UEXn and fed back by the UEXn (n=0, 1, 2), calculates the joint information consisting of the codeword limit cluster and the power level limit cluster coming from the TPX based on the principle of minimizing interference, and sends the joint information to the TPX through the connection interface of the TPY and the TPX;

supposing that in the basic unit resource CB1, the optimal codewords of the UEX0, the UEX1 and the UEX2 are respectively B0, B3 and B4; the TPX learns through the joint information that in the basic unit resource CB1, the codeword B4 corresponding to the UEX2 is not in the corresponding codebook limit cluster, so the TPX preferably schedules the UEX2 in the CB1.

In the present application example, the nodes learn, through the joint information interaction, a terminal in the present cell that generates interference with the neighboring nodes in the basic unit resource, thus avoiding scheduling the interfering terminal in the basic unit resource, reducing interference with the neighboring nodes, and ensuring the overall system throughput and the edge user experience.

### Application Example 2

The application scenario comprises two nodes TPX and TPY, there are three UEs, respectively UEX0, UEX1 and UEX2, under the TPX coverage, and there are three UEs, respectively UEY1, UEY1 and UEY2, under the TPY coverage.

In STEP1, the TPX measures or receives the link state information from the TPX to the UEXn and fed back by the UEXn (n=0, 1, 2);

in STEP2, the TPX calculates an interference codewords, and a power level limit value as well as the priority level indication information corresponding to the codeword coming from the TPY based on the principle of minimizing interference; a plurality of interference codewords constitute a codebook limit cluster, a plurality of power level limit values constitute a power level limit cluster, a plurality of pieces of priority indication information constitute a priority indication information cluster, and the codebook limit cluster, the power level limit cluster and the priority indication information cluster constitute the joint information;

in STEP3, the TPX sends the joint information to the TPY through the interface of the TPX and the TPY;

in STEP4, assuming that in the basic unit resource CB2, the optimal codewords of the UEY1, the UEY1 and the UEY2 are respectively B4, B5 and B6; when the TPY schedules, the TPY learns through the joint information that in the basic unit resource CB2, the optimal codewords corresponding to the UEY1, the UEY1 and the UEY2 are all within the codebook limit cluster, then the TPY does not schedule any UE in the CB2.

Similarly, the TPY measures or receives the link state information from the TPX to the UEXn and fed back by the UEXn (n=0, 1, 2), calculates the joint information consisting of the codeword limit cluster, the power level limit cluster, as well as the priority indication information cluster coming from the TPY based on the principle of minimizing interference, and sends the joint information to the TPX through the connection interface of the TPY and the TPX;

assuming that in the basic unit resource CB1, the optimal codewords of the UEX0, the UEX1 and the UEX2 are respectively B0, B3 and B4; the TPX learns through the joint information that in the basic unit resource CB1, the codeword B4 corresponding to the UEX2 is not in the corresponding codebook limit cluster, so the TPX preferably schedules the UEX2 in the CB1.

### Application Example 3

The application scenario comprises two nodes TPX and TPY, there are three UEs, respectively UEX0, UEX1 and UEX2, under the TPX coverage, and there are three UEs, respectively UEY1, UEY1 and UEY2, under the TPY coverage.

In STEP1, the TPX measures or receives the link state information from the TPX to the UEXn and fed back by the UEXn (n=0, 1, 2);

in STEP2, the TPX calculates the joint information consisting of the codebook limit cluster, the power level limit cluster and the priority indication information cluster coming from the TPY based on the principle of minimizing interference;

in STEP3, the TPX sends the joint information to the TPY through the interface of the TPX and the TPY;

in STEP4, assuming that in the basic unit resource CB2, the optimal codewords of the UEY1, the UEY1 and the UEY2 are respectively B4, B5 and B6. When the TPY schedules, the TPY learns through the joint information that in the basic unit resource CB2, the optimal codewords corresponding to the UEY1, the UEY1 and the UEY2 are all within the codebook limit cluster, and by judging the relationship of sizes of the power limit level P4 corresponding to the B4, the power limit level P5 corresponding to the B5, and the power limit level P6 corresponding to the B6, and P4<P5<P6, the TPY can learn that, by using the P6, it can use a higher power limit level to send, so the TPY preferably schedules the UEY2 in the corresponding basic unit resource CB2.

Similarly, the TPY measures or receives the link state information from the TPY to the UEYn and fed back by the UEYn (n=0, 1, 2), calculates the joint information consisting of the codeword limit cluster, the power level limit cluster, as well as the priority indication information cluster coming from the TPX based on the principle of minimizing interference, and sends the joint information to the TPX through the connection interface of the TPY and the TPX.

Assuming that in the basic unit resource CB1, the optimal codewords corresponding to the UEX0, the UEX1 and the UEX2 are respectively B0, B1 and B2; the TPX learns through the joint information that in the basic unit resource CB1, the optimal codewords corresponding to the UEX0, the UEX1 and the UEX2 are all in the codebook limit cluster, and by judging the relationship of sizes of the power level limit value P0 corresponding to the B0, the power level limit value P1 corresponding to the B1, and the power level limit value P2 corresponding to the B2, and P0<P1<P2, the TPX can learn that, by using the P2, it can use a higher power level to send, so the TPX preferably schedules the UEX2 in the corresponding unit resource CB1.

The present application example preferably schedules a terminal with a relatively high power limit level when the terminals within the coverage are all the terminals of the limit codewords, to reduce interference with the neighboring nodes and increase the flexibility of the scheduling of the present node.

### Application Example 4

Suppose there are two nodes, respectively TPX and TPY, there are two UEs, respectively UEX0 and UEX1, under the TPX coverage, and there are two UEs, respectively UEY1 and UEY1, under the TPY coverage.

In STEP1, the TPX measures or receives the link state information from the TPX to the UEXn and fed back by the UEXn (n=0, 1, 2);

in STEP2, the TPX calculates the interference codeword and the interference level indication information corresponding to the codeword coming from the TPY; and the codebook limit cluster and the interference level indication information cluster constitute the joint information;

in STEP3, the TPX sends the joint information to the TPY through the interface of the TPX and the TPY;

in STEP4, assuming that in the basic unit resource CB2, the optimal codewords of the UEY1 and the UEY1 are respectively B4 and B5; when the TPY schedules, the TPY learns through the joint information that in the basic unit resource CB2, the optimal codewords corresponding to the UEY1, UEY1 and the UEY2 are all within the codebook limit cluster, and by judging the interference level I4 corresponding to the B4 and the interference level I5 corresponding to the B5, and I4<I5, the TPY can learn that, by using the B4 to perform the data transmission, it can reduce the interference with the TPX as much as possible, so that the TPY preferably schedules the UEY1 in the corresponding unit resource.

Similarly, the TPY measures or receives the link state information from the TPY to the UEYn and fed back by the UEYn (n=0,1), calculates the joint information consisting of the codeword limit cluster and the interference level indication information cluster coming from the TPX based on the principle of minimizing interference, and sends the joint information to the TPX through the connection interface of the TPY and the TPX;

assuming that in the basic unit resource CB1, the optimal codewords of the UEX0 and the UEX1 are respectively B0 and B1. The TPX learns through the joint information that in the basic unit resource CB1, all the codewords corresponding to the UEXn are all in the codebook limit cluster corresponding to the basic unit resource position, and by judging the interference level JO corresponding to the B0 and the interference level I1 corresponding to the B1, and I0<I1, the TPX can learn that, by using the B0 to perform data transmission, it can reduce interference with the TPY as much as possible, so the TPX preferably schedules the UEX0 in the corresponding unit resource.

The abovementioned interference level may be 1-bit information, each codeword corresponds to one interference level, the bit 0 represents that the corresponding codeword is a codeword with a low interference level, and the bit 1 represents that the corresponding codeword is a codeword with a high interference level.

The present application example introduces the concept of interference level, when an interference node selects one interference codeword for transmitting, it tries to select a codeword with low interference level, which can make the interference of the interference node with the neighboring nodes is minimized.

### Application Example 5

Assuming that there are two nodes, respectively TPX and TPY, there exist three UEs, respectively UEX0, UEX1 and UEX2, under the TPX coverage; and there are three UEs, respectively UEY1, UEY1 and UEY2, under the TPY coverage.

In STEP1, the TPX measures or receives the link state information from TPX to UEXn and fed back by the UEXn (n=0,1);

in STEP2, the TPX calculates the interference codeword and the power level limit value and the priority indication information corresponding to the codeword coming from the TPY; wherein the codebook limit cluster, the power level limit cluster and the priority indication information cluster constitute the joint information;

in STEP3, the TPX sends the joint information to the TPY through the interface of the TPX and the TPY;

in STEP4, assuming that in the basic unit resource CB2, optimal codebook weights of the UEY1, the UEY1 and the UEY2 are respectively B4, B5 and B6. When the TPY schedules, the TPY learns through the joint information that, in the basic unit resource CB2, codewords corresponding to the UEY1, the UEY1 and the UEY2 are all within the codebook limit cluster corresponding to the basic unit resource position, and the TPY judges that the order or the index corresponding to the B4 is index 4, the order or the index corresponding to the B5 is index 5, and the order or the index corresponding to the B6 is index 6, and index 4<index 5<index 6, and it can learn that the Index4 has the smallest index value, and correspondingly the B4 has the highest scheduling priority, therefore, the TPY preferably schedules the UEY1 in the corresponding unit resource.

Similarly, the TPY measures or receives the link state information from the TPY to the UEYn and fed back by the UEYn (n=0, 1, 2), calculates the joint information consisting of the codebook limit cluster, the power level limit cluster and the priority indication information cluster coming from the TPX based on the principle of minimizing interference, and sends the joint information to the TPX through the connection interface of the TPY and the TPX;

assuming that in the basic unit resource CB1, the optimal codewords of the UEX0, the UEX1 and the UEX2 are respectively B0, B1 and B2. The TPX learns through the joint information that in the basic unit resource CB1, codewords corresponding to all the 0 are all within the codebook limit cluster corresponding to the basic unit resource position, the TPX judges that the order or index corresponding to the B0 is Index0, the order or index corresponding to the B1 is Index1, and the order or index corresponding to the B2 is Index2, and Index0<Index1<Index2, it can learn that the Index0 has the smallest index value, correspondingly that the B0 has the highest scheduling priority, so the TPX preferably schedules the UEX0 in the corresponding basic unit resource.

The present application example introduces an implicit representation method of priority indication information, which can reduce signaling overhead.

### Application Example 6

Supposing there are two nodes, respectively TPX and TPY, there exist three UEs, respectively UEX0, UEX1 and UEX2 under the TPX coverage, and there are three UEs, respectively UEY1, UEY1 and UEY2 under the TPY coverage;

in STEP1, the TPX measures or receives the link state information from TPX to UEXn fed back by the UEXn (n=0, 1, 2);

in STEP2, the TPX calculates the interference codeword and the priority indication information corresponding to the codeword coming from the TPY; wherein the codebook limit cluster and the priority indication information cluster constitute the joint information;

in STEP3, the TPX sends the joint information to the TPY through the interface of the TPX and the TPY;

in STEP4, assuming that in the basic unit resource CB2, optimal codewords of the UEY1, the UEY1 and the UEY2 are respectively B4, B5 and B6. When the TPY schedules, the TPY learns through the joint information that, in the basic unit resource CB2, the codewords corresponding to the UEY1, the UEY1 and the UEY2 are all within the codebook limit cluster corresponding to the basic unit resource, and the TPY judges that the order or index corresponding to the B4 is Index 4, the order or index corresponding to the B5 is Index 5, and the order or index corresponding to the B6 is Index 6, and Index 4<Index 5<Index 6, it can learn that the Index4 has the smallest index value, and correspondingly the B4 has the highest scheduling priority, so the TPY preferably schedules the UEY1 in the corresponding unit resource.

Similarly, the TPY measures or receives the link state information from the TPY to the UEYn and fed back by the UEYn (n=0, 1, 2), calculates the joint information consisting of the codebook limit cluster and the priority indication information cluster coming from the TPX based on the principle of minimizing interference, and sends the joint information to the TPX through the connection interface of the TPY and the TPX;

assuming that in the basic unit resource CB1, the optimal codewords of the UEX0, the UEX1 and the UEX2 are respectively B0, B1 and B2. The TPX learns through the joint information that in the basic unit resource CB1, the codebook B4 corresponding to all the UEXn are all within the codebook limit cluster corresponding to the basic unit resource position, the TPX judges that the order or index corresponding to the B0 is Index0, the order or index corresponding to the B1 is Index1, and the order or index corresponding to the B2 is Index2, and Index0<Index1<Index2, it can learn that the Index0 has the smallest index value, correspondingly the B0 has the highest scheduling priority, so the TPX preferably schedules the UEX0 in the corresponding unit resource.

### Application Example 7

Suppose there are two nodes, respectively TPX and TPY, there exist three UEs, respectively UEX0, UEX1 and UEX2 under the TPX coverage, and there are three UEs, respectively UEY1, UEY1 and UEY2 under the TPY coverage.

In STEP1, the TPX measures or receives the link state information from the TPX to the UEXn and fed back by the UEXn (n=0, 1, 2);

in STEP2, the TPX calculates the interference codeword and the priority indication information corresponding to the codeword coming from the TPY; and the codebook limit cluster and the priority indication information cluster constitute the joint information;

in STEP3, the TPX sends the joint information to the TPY through the interface of the TPX and the TPY;

in STEP4, assuming that in the basic unit resource CB2, optimal codewords of the UEY1, the UEY1 and the UEY2 are respectively B4, B5 and B6. When the TPY schedules, the TPY learns through the joint information that, codewords corresponding to the UEY1, the UEY1 and the UEY2 are all within the codebook limit cluster corresponding to the basic unit resource position, and the TPY judges that the priority indication signaling corresponding to the B4 is PR4, the priority indication signaling corresponding to the B5 is PR5, and the priority indication signaling corresponding to the B6 is PR6, and PR4<PR5<PR6, and correspondingly the PR6 has the highest scheduling priority, so the TPY preferably schedules the UEY2 in the corresponding unit resource.

Similarly, the TPY measures or receives the link state information from the TPY to the UEYn and fed back by the UEYn (n=0, 1, 2), calculates the joint information consisting of the codebook limit cluster and the priority indication information cluster coming from the TPX, and sends the joint information to the TPX through the connection interface of the TPY and the TPX;

assuming that in the basic unit resource CB1, the optimal codewords of the UEX0, the UEX1 and the UEX2 are respectively B0, B1 and B2. The TPX learns through the joint information that codewords corresponding to all the UEXn are all within the codebook limit cluster corresponding to the basic unit resource position, the TPX judges that the priority indication signaling corresponding to the B0 is PR0, the priority indication signaling corresponding to the B1 is PR1, and the priority indication signaling corresponding to the B2 is PR2, and PR0<PR1<PR2, it can learn that the PR2 has the highest scheduling priority, so the TPX preferably schedules the UEX2 in the corresponding unit resource.

The present application example indicates the interference level through the priority information, so as to ensure that the interference degree and frequency of the interference node with the neighboring nodes as small as possible.

### Application Example 8

Assume that there are two nodes, respectively TPX and TPY, there exist three UEs, respectively UEX0, UEX1 and UEX2, under the TPX coverage, and there are three UEs, respectively UEY1, UEY1 and UEY2 under the TPY coverage.

In STEP1, the TPX measures or receives the link state information from the TPX to the UEXn and fed back by the UEXn (n=0, 1, 2);

in STEP2, the TPX calculates the interference codeword and the power level limit value and the priority indication information corresponding to the codeword coming from the TPY; wherein the codebook limit cluster, the power level limit cluster and the priority indication information cluster constitute the joint information;

in STEP3, the TPX sends the joint information to the TPY through the interface of the TPX and the TPY;

in STEP4, assuming that in the basic unit resource CB2, optimal codewords of the UEY1, the UEY1 and the UEY2 are respectively B4, B5 and B6. When the TPY schedules, the TPY learns through the joint information that codewords corresponding to the UEY1, the UEY1 and the UEY2 are all within the codebook limit cluster corresponding to the basic unit resource position, and the TPY judges that the maximum gain can be obtained in combination with the power level limit in the corresponding basic unit resource, and if the difference of the maximum gains obtained by respective UEYn does not exceed a threshold N, then it also needs to check the priority information, assuming that the priority of using the B4 is the highest, the TPY preferably schedules the UEY1 in the corresponding unit resource. The gain can be the average spectrum efficiency, the average throughout as well as SINR and Matrix calculated through certain equations, of the cell.

Similarly, the TPY measures or receives the link state information form the TPY to the UEYn and fed back by the UEYn (n=0, 1, 2), calculates the joint information consisting of the codebook limit cluster, the power level limit cluster and the priority indication information limit cluster coming from the TPX, and sends the joint information to the TPX through the connection interface of the TPY and the TPX;

assuming that in the basic unit resource CB1, the optimal codewords of the UEX0, the UEX1 and the UEX2 are respectively B0, B3 and B4. The TPX learns through the joint information that the codeword B4 corresponding to the UEX2 is not within the codebook limit cluster corresponding to the basic unit resource position, so the TPX preferably schedules the UEX2 in the corresponding unit resource.

The present application example further introduces the case of the interference node comprehensively deciding the scheduling of the present node based on the scheduling gain information of the present node and combined with the received joint information, thus ensuring to increase the average spectral efficiency of the present node under the circumstance that the interference with the neighboring nodes is as small as possible.

### Application Example 9

Supposing there are two nodes, respectively TPX and TPY, there exist three UEs, respectively UEX0, UEX1 and UEX2, under the TPX coverage; and there are three UEs, respectively UEY1, UEY1 and UEY2, under the TPY coverage.

In STEP1, the TPX measures or receives the link state information from the TPX to the UEXn and fed back by the UEXn (n=0, 1, 2);

in STEP2, the TPX calculates the interference codeword coming from the TPY and the power level limit value corresponding to the codeword; wherein the codebook limit cluster and the power level limit cluster constitute the joint information;

in STEP3, the TPX sends the joint information to the TPY through the interface of the TPX and the TPY;

in STEP4, assuming that in the basic unit resource CB2, optimal codewords of the UEY1, the UEY1 and the UEY2 are respectively B4, B5 and B6. When the TPY schedules, the TPY learns through the joint information that codewords corresponding to the UEY1, the UEY1 and the UEY2 are all within the codebook limit cluster corresponding to the basic unit resource position, and the TPY judges that the power limit level corresponding to the B4 is P4, the power limit level corresponding to the B5 is P5, and the power limit level corresponding to the B6 is P6, and with the B4, the B5 and the B6, the TPY selects and decides the scheduling priority based on the gain obtained in the corresponding basic unit resource. For example, when the obtained gain of scheduling the B4 under the power limit P4 is G4, the obtained gain of scheduling the B5 under the power limit P5 is G5, and the obtained gain of scheduling the B6 under the power limit P6 is G6, and G4<G5<G6, and using the B6 to schedule the UEY2 under the corresponding power limit P6 can obtain the maximum system gain in the basic unit resource, so the TPY preferably schedules the UEY2 in the corresponding unit resource. Wherein, the gain is the average spectrum efficiency, the average throughout, as well as the SINK and Matrix calculated according to certain equations, of the cell.

Similarly, the TPY measures or receives the link state information from the TPY to the UEYn and fed back by the UEYn (n=0, 1, 2), calculates the joint information consisting of the codebook limit cluster and the power level limit cluster coming from the TPX, and sends the joint information to the TPX through the connection interface of the TPY and the TPX;

assuming that in the basic unit resource CB1, the optimal codewords of the UEX0, the UEX1 and the UEX2 are respectively B0, B3 and B4. The TPX learns through the joint information that the codebook B4 corresponding to the UEX2 is not within the codebook limit cluster corresponding to the basic unit resource position, so the TPX preferably schedules the UEX2 in the corresponding basic resource.

### Application Example 10

Assuming that there are two nodes, respectively TPX and TPY, there exist three UEs, respectively UEX0, UEX1 and UEX2 under the TPX coverage, and there are three UEs, respectively UEY1, UEY1 and UEY2 under the TPY coverage.

In STEP1, the TPX measures or receives the link state information from the TPX to the UEXn and fed back by the UEXn (n=0, 1, 2);

in STEP2, the TPX calculates the interference codeword, and the power level limit value and the priority indication information corresponding to the codeword coming from the TPY; and the codebook limit cluster, the power level limit cluster and the priority indication information cluster constitute the joint information;

in STEP3, the TPX sends the joint information to the TPY through the interface of the TPX and the TPY;

in STEP4, assuming that in the basic unit resource CB2, optimal codewords of the UEY1, the UEY1 and the UEY2 are respectively B4, B5 and B6. When the TPY schedules, the TPY learns through the joint information that, codewords corresponding to the UEY1, the UEY1 and the UEY2 are all within the codebook limit cluster corresponding to the basic unit resource position, and the TPY judges that the priority indication signaling corresponding to the B4 is PR4, the priority indication signaling corresponding to the B5 is PR5, and the priority indication signaling corresponding to the B6 is PR6, and PR4=PR5=PR6, the TPY continues to judge that the power limit level corresponding to the B4 is P4, the power limit level corresponding to the B5 is P5, and the power limit level corresponding to the B6 is P6, and with the B4, the B5 and the B6, the TPY selects and decides the scheduling priority based on the gain obtained in the corresponding basic unit resource. For example, when the obtained gain of scheduling the B4 under the power level limit P4 is G4, the obtained gain of scheduling the B5 under the power level limit P5 is G5, and the obtained gain of scheduling the B6 under the power level limit P6 is G6, G4<G5<G6, and using the B6 to schedule the UEY2 under the corresponding power limit P6 can obtain the maximum system gain in the basic unit resource, so the TPY preferably schedules the UEY2 in the corresponding unit resource. Wherein, the gain is the average spectral efficiency, the average throughout, as well as the SINR and Matrix calculated according to certain equations, of the cell.

Similarly, the TPY measures or receives the link state information from the TPY to the UEYn AND fed back by the UEYn (n=0, 1, 2), calculates the joint information consisting of the codebook limit cluster, the power level limit cluster and the priority indication information cluster coming from the TPX, and sends the joint information to the TPX through the connection interface of the TPY and the TPX;

assuming that in the basic unit resource CB1, the optimal codewords of the UEX0, the UEX1 and the UEX2 are respectively B0, B1 and B2. The TPX learns through the joint information that codewords corresponding to all the UEXn are all within the codebook limit cluster corresponding to the basic unit resource position, the TPX judges that the priority indication signaling corresponding to the B0 is PR0, the priority indication signaling corresponding to the B1 is PR1, and the priority indication signaling corresponding to the B2 is PR2, and PR0<PR1<PR2, it can learn that the PR2 has the highest scheduling priority, so the TPX preferably schedules the UEX2 in the corresponding basic resource.

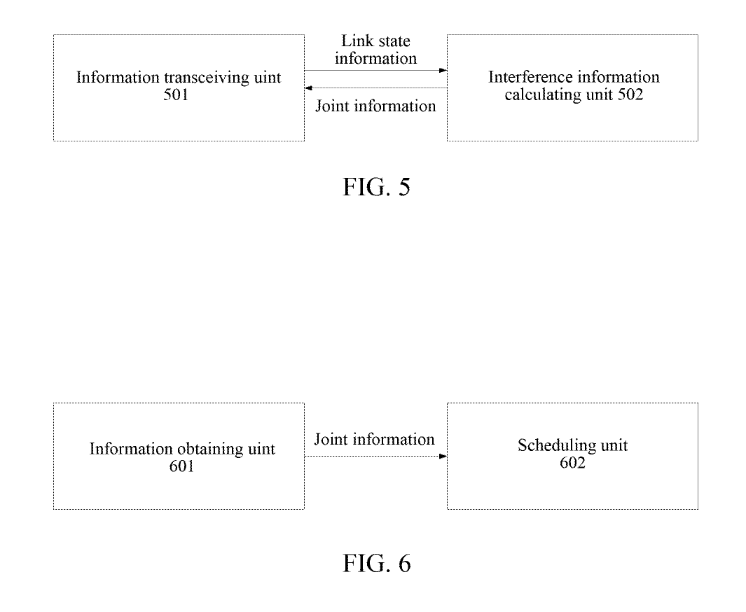

FIG. 5 is a schematic diagram of the composition structure of the inter-node interference reduction node in accordance with an embodiment of the present invention.

The first node comprises at least one processor executing an information transceiving unit 501 and an interference information calculating unit 502, wherein,

the information transceiving unit 501 is configured to: obtain link state information fed back by a terminal within a coverage range of the node, send the link state information to the interference information calculating unit; and send joint information sent by the interference information calculating unit to a second node that interferes with the terminal;

the interference information calculating unit 502 is configured to: calculate joint information reflecting the interference of the second node with the terminal according to the link state information, and return the joint information to the information transceiving unit; wherein, the joint information comprises a codebook limit cluster, and further comprising one or more of a power level limit cluster, a priority indication information cluster and an interference level indication cluster, for example, the joint information can be the codebook limit cluster and the power level limit cluster, the codebook limit cluster and the priority indication information cluster, the codebook limit cluster and the interference level indication information cluster, or the codebook limit cluster and the power level limit cluster as well as the priority indication information cluster; a correspondence exists between constituent elements of any piece(s) of information in the joint information and constituent elements of other information except the any piece(s) of information in the joint information, and if the joint information is the codebook limit cluster and the power level limit cluster, each codeword in the codebook limit cluster has a corresponding power level limit value in the power level limit cluster.

The abovementioned codebook limit cluster refers to a set consisting of codewords that would generate interference with the terminal; the codeword in the codebook limit cluster may use codewords with rank being 1 in order to reduce the signaling overhead; the power level limit cluster and the interference level indication information cluster respectively limit the maximum allowed power and the minimum generated interference for the second node scheduling terminals corresponding to the codewords; the power limitation levels may reflect the interference levels, and compared to a codeword with a low power limit level, a codeword with a high power limit level generates relatively small interference with the first node; the priority indication information cluster reflects the priorities used by the codewords in the codebook limit cluster.

When the abovementioned joint information comprises the priority indication information cluster, the priority indication information in the priority indication information cluster is represented in the following manner:

representing priority indication information of the corresponding codeword by setting a priority indication signaling for each codeword in the codebook limit cluster, wherein the abovementioned priority indication signaling can be represented with a bitmap sequence, for example, the bit 0 in the sequence represents a low priority, and 1 represents a high priority; or,

representing the priority indication information of the corresponding codeword according to the arrangement order or index value of the codeword in the codebook limit cluster, wherein with the change of the arrange order of the codeword from front to back or the index value of the codeword from low to high, the priority of the codeword increases, or, with the change of the arrangement order of the codeword from front to back or the index value of the codeword from low to high, the priority of the codeword decreases.

The abovementioned interference information calculating unit is configured to calculate the joint information reflecting the interference of another node with the terminal based on the link state information, comprising: calculating the joint information reflecting the interference of the other node with the terminal in the basic unit resource based on the link state information in each basic unit resource; wherein, the basic unit resource comprises one or more of the following information: resource block, resource block pair, subband, resource block group (RBG), precoding resource group (PRG), subframe cluster, and radio frame cluster; wherein the resource block, the resource block pair, the subband, the RBG and the PRG are basic constituent elements of the basic unit resource.

When the basic unit resource comprises the resource blocks, the resource blocks are represented with a bitmap, each bit in the bitmap sequence represents one resource block, and the length of the bitmap sequence is equal to the number of all the resource blocks;

when the basic unit resource comprises the resource block pairs, the resource block pairs are represented with a bitmap, each bit in the bitmap sequence represents one resource block pair, and the length of the bitmap sequence is equal to the number of all the resource block pairs;

when the basic unit resource comprises the subbands, the subbands are represented with a bitmap, each bit in the bitmap sequence represents one subband, and the length of the bitmap sequence is equal to the number of all the subbands;

when the basic unit resource comprises the RBGs, the RBGs are represented with a bitmap, each bit in the bitmap sequence represents one RBG, and the length of the bitmap sequence is equal to the number of all the RBGs;

when the basic unit resource comprises the PRGs, the PRGs are represented with a bitmap, each bit in the bitmap sequence represents one PRG, and the length of the bitmap sequence is equal to the number of all the PRGs;

when the basic unit resource comprises the subframe cluster, the sub-frame cluster is represented with a bitmap, each bit in the bitmap sequence represents one subframe, and the length of the bitmap sequence is equal to the number of all the subframes;

when the basic constituent element of the basic unit resource comprises the subframes, the subframe cluster may consist of a plurality of subframes configured with the same joint information, the joint information carried by different subframe clusters is different; the subframe cluster where the subframes are located is obtained through the equation x=mod(SF, F(n)), wherein n is the subframe cluster index, SF is the subframe index, F(n) is the modulo coefficient corresponding to the subframe cluster n, when x=n, it demonstrates that the subframes are located within the subframe cluster n;

when the basic unit resource comprises the radio frame cluster, the radio frame cluster is represented with a bitmap, each bit in the bitmap sequence represents one radio frame, and the length of the bitmap sequence is equal to the number of all the radio frames.

when the basic constituent elements of the basic unit resources comprise the radio frames, the radio frame cluster may consist of a plurality of radio frames configured with the same joint information, and the joint information carried by different radio frame clusters is different; the radio frame cluster where the radio frames are located is obtained by the equation x=mod(SF, F(n)), wherein n is the radio frame cluster index, SF is the subframe index, F(n) is the modulo coefficient corresponding to the radio frame cluster n, and when x=n, it demonstrates that the radio frames are located within the radio frame cluster n.

FIG. 6 is a schematic diagram of the composition structure of the inter-node interference reduction node in accordance with an embodiment of the present invention.

The second node comprises at least one processor executing an information obtaining unit 601 and a scheduling unit 602, wherein,

the information obtaining unit 601 is configured to: obtain joint information coming from a first node and reflecting interference of the present node with a terminal within a coverage range of the first node, and send the joint information to the scheduling unit; wherein, the joint information comprises the codebook limit cluster, and further comprises one or more of the power level limit cluster, the priority indication information cluster and the interference level indication information cluster;

the scheduling unit 602 is configured to: schedule a terminal within a coverage range of the present node based on the joint information; comprising: judging whether terminal codewords in the coverage of the present node are all included in the codebook limit cluster in the joint information, if there exist a terminal codeword not included in the codebook limit cluster, then scheduling a terminal corresponding to the terminal codeword; if the terminal codewords in the coverage range of the present node are all included in the codebook limit cluster in the joint information, selecting a terminal to be scheduled according to information except the codebook limit cluster in the joint information, or not scheduling any terminal.

When selecting the terminal to be scheduled based on other information except the codebook limit cluster in the joint information, it is to select to use the other information to schedule a terminal that has small interference with the first node, such as selecting a terminal with a high power level limit value, selecting a terminal with a high priority or a terminal with a low interference level, and further it may calculate a system gain generated by scheduling the terminal of the corresponding codeword according to the power level limit cluster, and select a terminal with the maximum system gain as a terminal to be scheduled.

The embodiment of the present invention further provides an inter-node interference reduction system, wherein the system comprises: the node shown in FIG. 5 and the node shown in FIG. 6, which will not be repeated here.

The focus of the embodiment of the present invention is to protect interactive signaling content between the TPs as well as the corresponding format and the correspondence, specific actions applied after the TP receives the signalings can be any implementation issue, which does not limit the method used in the embodiments of the present patent, and they should be within the protection scope of the present invention.

Those ordinarily skilled in the art can understand that all or some of steps of the abovementioned method may be completed by the programs instructing the relevant hardware, and the programs may be stored in a computer-readable storage medium, such as read only memory, magnetic or optical disk. Alternatively, all or some of the steps of the abovementioned embodiments may also be implemented by using one or more integrated circuits. Accordingly, each module/unit in the abovementioned embodiments may be realized in a form of hardware, or in a form of software function modules. The present invention is not limited to any specific form of hardware and software combinations.

It should be noted that, the present invention may also have other various embodiments, and without departing from the rule and essence of the present invention, those skilled in the art can make various appropriate changes and modifications of the present invention, and these appropriate changes and modifications should belong to in the protection scope of the appended claims of the present invention.

### INDUSTRIAL APPLICABILITY

The embodiment of the present invention does not require to use an ideal backhaul between the cells because the wireless link is used between the cells to interact, and the joint information of the interference, learned by the present node, of the neighboring nodes with a terminal of the present node comprises a plurality of factors that cause the interference, so that the interference suppression is more reasonable. Therefore, the present invention has very strong industrial applicability.

What is claimed is:

1. An inter-node interference reduction method, comprising:
a first node obtaining link state information fed back by a terminal within a coverage range of the first node;
the first node calculating joint information reflecting interference of a second node with the terminal based on the link state information, and sending the joint information to the second node; and
the second node scheduling a terminal within a coverage range of the second node based on the joint information;
wherein, the joint information comprises a codebook limit cluster, and further comprises one or more of a power level limit cluster, a priority indication information cluster and an interference level indication information cluster, and a correspondence exists between constituent elements of any piece(s) of information in the joint information and constituent elements of other information except the any piece(s) of information in the joint information.

2. The inter-node interference reduction method of claim 1, wherein, when the joint information comprises the priority indication information cluster, the priority indication information in the priority indication information cluster is represented in the following manner:
representing the priority indication information of a corresponding codeword by setting a priority indication signaling for a codeword in each codebook limit cluster;
or,
representing the priority indication information of a corresponding codeword based on an arrangement order or index value of the codeword in the codebook limit cluster, with a change of the arrange order of the codeword from front to back or the index value of the codeword from low to high, a priority of the codeword increasing, or, with a change of the arrangement order of the codeword from front to back or the index value of the codeword from low to high, a priority of the codeword decreasing.

3. The inter-node interference reduction method of claim 1, wherein, the step of the first node calculating joint information reflecting interference of a second node with the terminal based on the link state information comprises:
the first node, based on the link state information in each basic unit resource, calculating the joint information reflecting the interference of the second node with the terminal in the basic unit resource;
wherein, the basic unit resource comprises one or more of the following information:
resource block, resource block pair, subband, resource block group (RBG), precoding resource group (PRG), subframe cluster, and radio frame cluster.

4. The inter-node interference reduction method of claim 3, wherein,
when the basic unit resource comprises the resource blocks, the resource blocks are represented with a bitmap, each bit in the bitmap sequence represents one resource block, and a length of the bitmap sequence is equal to a number of all the resource blocks;
when the basic unit resource comprises the resource block pairs, the resource block pairs are represented with a bitmap, each bit in the bitmap sequence represents one resource block pair, and a length of the bitmap sequence is equal to a number of all the resource block pairs;
when the basic unit resource comprises the subbands, the subbands are represented with a bitmap, each bit in the bitmap sequence represents one subband, and a length of the bitmap sequence is equal to a number of all the subbands;
when the basic unit resource comprises the RBGs, the RBGs are represented with a bitmap, each bit in the bitmap sequence represents one RBG, and a length of the bitmap sequence is equal to a number of all the RBGs;
when the basic unit resource comprises the PRGs, the PRGs are represented with a bitmap, each bit in the bitmap sequence represents one PRG, and a length of the bitmap sequence is equal to a number of all the PRGs;
when the basic unit resource comprises the subframe cluster, the subframe cluster is represented with a bitmap, each bit in the bitmap sequence represents one subframe, and a length of the bitmap sequence is equal to a number of all the subframes;
when the basic unit resource comprises the subframe cluster, the subframe cluster is represented with a bitmap, each bit in the bitmap sequence represents one subframe, and a length of the bitmap sequence is equal to a number of all the subframes; and
when the basic unit resource comprises the radio frame cluster, the radio frame cluster is represented with a bitmap, each bit in the bitmap sequence represents one radio frame, and a length of the bitmap sequence is equal to a number of all the radio frames.

5. The inter-node interference reduction method of claim 1, wherein, the step of the second node scheduling a terminal within a coverage range of the second node based on the joint information comprises:
the second node judging whether terminal codewords within the coverage range of the present node are all included in the codebook limit cluster in the joint information, if there exist a terminal codeword not included in the codebook limit cluster, then scheduling a terminal corresponding to the terminal codeword; if the terminal codewords within the coverage range of the present node are all included in the codebook limit cluster in the joint information, selecting a terminal to be scheduled based on other information except the codebook limit cluster in the joint information, or not scheduling a terminal.

6. The inter-node interference reduction method of claim 5, wherein, when the joint information comprises the power level limit cluster, the step of selecting a terminal to be scheduled based on other information except the codebook limit cluster in the joint information comprises:
calculating a system gain generated by scheduling a terminal of a corresponding codeword based on the power level limit cluster, and selecting a terminal with a maximum system gain as the terminal to be scheduled.

7. An inter-node interference reduction node, comprising an information transceiving unit and an interference information calculating unit, wherein,
the information transceiving unit is configured to: obtain link state information fed back by a terminal within a coverage range of the node, send the link state information to the interference information calculating unit; and send joint information sent by the interference information calculating unit to a second node that interferes with the terminal; and
the interference information calculating unit is configured to: calculate joint information reflecting interference of the second node with the terminal based on the link state information, and return the joint information to the information transceiving unit;
wherein, the joint information comprises a codebook limit cluster, and further comprises one or more of a power level limit cluster, a priority indication information cluster and an interference level indication cluster, and a correspondence exists between constituent elements of any piece(s) of information in the joint information and constituent elements of other information except the any piece(s) of information in the joint information.

8. The inter-node interference reduction node of claim 7, wherein, when the joint information comprises the priority indication information cluster, the priority indication information in the priority indication information cluster is represented in the following manner:
representing the priority indication information of a corresponding codeword by setting a priority level indication signaling for a codeword in each codebook limit cluster;
or,
representing the priority indication information of a corresponding codeword based on an arrangement order or index value of the codeword in the codebook limit cluster, with a change of the arrangement order of the codeword from front to back or the index value of the codeword from low to high, a priority of the codeword increasing, or, with a change of the arrangement order of the codeword from front to back or the index value of the codeword from low to high, a priority of the codeword decreasing.

9. The inter-node interference reduction node of claim 7, wherein, the interference information calculating unit is configured to calculate joint information reflecting interference of the second node with the terminal based on the link state information in the following manner:
based on the link state information in each basic unit resource, calculating the joint information reflecting the interference of the second node with the terminal in the basic unit resource;
wherein, the basic unit resource comprises one or more of the following information:
resource block, resource block pair, subband, resource block group (RBG), precoding resource group (PRG), subframe cluster, and radio frame cluster.

10. The inter-node interference reduction node of claim 9, wherein,
when the basic unit resource comprises the resource blocks, the resource blocks are represented with a bitmap, each bit in the bitmap sequence represents one resource block, and a length of the bitmap sequence is equal to a number of all the resource blocks;
when the basic unit resource comprises the resource block pairs, the resource block pairs are represented with a bitmap, each bit in the bitmap sequence represents one resource block pair, and a length of the bitmap sequence is equal to a number of all the resource block pairs;
when the basic unit resource comprises the subbands, the subbands are represented with a bitmap, each bit in the bitmap sequence represents one subband, and a length of the bitmap sequence is equal to a number of all the subbands;
when the basic unit resource comprises the RBGs, the RBGs are represented with a bitmap, each bit in the bitmap sequence represents one RBG, and a length of the bitmap sequence is equal to a number of all the RBGs;
when the basic unit resource comprises the PRGs, the PRGs are represented with a bitmap, each bit in the bitmap sequence represents one PRG, and a length of the bitmap sequence is equal to a number of all the PRGs;
when the basic unit resource comprises the subframe cluster, the subframe cluster is represented with a bitmap, each bit in the bitmap sequence represents one subframe, and a length of the bitmap sequence is equal to a number of all the subframes; and
when the basic unit resource comprises the radio frame cluster, the radio frame cluster is represented with a bitmap, each bit in the bitmap sequence represents one radio frame, and a length of the bitmap sequence is equal to a number of all the radio frames.

11. An inter-node interference reduction node, comprising: an information obtaining unit and a scheduling unit, wherein,
the information obtaining unit is configured to: obtain joint information coming from a first node and reflecting interference of the present node with a terminal within a coverage range of the first node, and sending the joint information to the scheduling unit;
the scheduling unit is configured to: schedule a terminal within a coverage range of the present node based on the joint information;
wherein, the joint information comprises a codebook limit cluster, and further comprises one or more of a power level limit cluster, a priority indication information cluster and an interference level indication information cluster.

12. The inter-node interference reduction node of claim 11, wherein, the scheduling unit is configured to schedule a terminal within a coverage range of the present node based on the joint information in the following manner:
judging whether terminal codewords within the coverage range of the present node are all included in the codebook limit cluster in the joint information, if there exist a terminal codeword not included in the codebook limit cluster, then scheduling a terminal corresponding to the terminal codeword; if the terminal codewords within the coverage range of the present node are all included in the codebook limit cluster in the joint information, selecting a terminal to be scheduled based on information except the codebook limit cluster in the joint information, or not scheduling a terminal.

13. The inter-node interference reduction node of claim 12, wherein, when the joint information comprises the power level limit cluster, the scheduling unit is configured to select a terminal to be scheduled based on information except the codebook limit cluster in the joint information in the following manner:
calculating a system gain generated by scheduling a terminal of a corresponding codeword based on the power level limit cluster, and selecting a terminal with a maximum system gain as the terminal to be scheduled.

14. An inter-node interference reduction system, comprising: the node of claim 7; and an inter-node interference reduction node which comprises an information obtaining unit and a scheduling unit, wherein,
the information obtaining unit is configured to: obtain joint information coming from a first node and reflecting interference of the present node with a terminal within a coverage range of the first node, and sending the joint information to the scheduling unit;
the scheduling unit is configured to: schedule a terminal within a coverage range of the present node based on the joint information;
wherein, the joint information comprises a codebook limit cluster, and further comprises one or more of a power level limit cluster, a priority indication information cluster and an interference level indication information cluster.
